(19) United States
(12) Patent Application Publication
(10) Pub. No.: US 2025/0018314 A1
(43) Pub. Date: Jan. 16, 2025

(54) PRESSURE-ASSISTED SEPARATION COLUMN

(71) Applicant: ECZACIBASI MONROL NÜKLEER ÜRÜNLER SANAYI VE TICARET ANONIM SIRKETI, Gebze/Kocaeli (TR)

(72) Inventors: Mehmet Tunç TUNÇEL, Gebze/Kocaeli (TR); Tahsin PEHLIVAN, Gebze/Kocaeli (TR); Isil ÇORUH, Gebze/Kocaeli (TR); Mustafa ÇAKMAK, Gebze/Kocaeli (TR)

(21) Appl. No.: 18/706,676

(22) PCT Filed: Jun. 9, 2022
(86) PCT No.: PCT/TR2022/050553

§ 371 Date: May 1, 2024

(30) Foreign Application Priority Data
Nov. 5, 2021 (TR) 2021/017242

(51) Int. Cl. B01D 15/22

(52) U.S. Cl. CPC B01D 15/22; B01D 2257/60; B01D 2257/93

(57) ABSTRACT

Disclosed is a separation column used for separating the substances in a mixture. More particularly, disclosed is a separation column including an additional inlet where the input of the mobile phase may be realized via a section between the column inlet and column outlet of the column, in addition to the column inlet.

### SUBJECT OF THE INVENTION

The invention relates to a separation column used for separating the substances in a mixture.

### STATE OF THE ART

Chromatography is a frequently preferred method in the applications where it is desired to separate two or more components in a mixture. The separation is realized by moving the components, which are desired to be separated by way of chromatography, at varying velocities through a stationary phase with the help of a mobile phase. In other words, the component desired to be separated is added to a stationary phase and is separated owing to the mobile phase flowing over this stationary phase.

A chromatography system basically consists of a stationary phase and a mobile phase, which also contains the mixture desired to be separated. The mobile phase moves over the other phase that is stationary. The mobile phase charged in the column occupies some space in the column and the separation process takes place in the other part of the column. The mobile phase that is to move over the stationary phase is charged at a certain pressure in the column. The mobile phase moving under the influence of said pressure passes over the stationary phase and is thus separated. The separation capacity and efficiency are expected to increase depending on the column length. However, as a result of the increase in the column length, a pressure drop occurs in the zones near the column outlet, i.e. in the parts distant from the column inlet, and this condition adversely affects the separation efficiency.

In the separation column according to the invention, the input of a second mobile phase is enabled via any section between the column outlet and inlet, in addition to the column inlet, and thus, the pressure drop near the column outlet is prevented.

### OBJECT OF THE INVENTION

An object of the invention is to develop a separation column wherein the pressure drop in the section near the outlet part of said separation column is eliminated.

Another object of the invention is to develop a column wherein the input of additional mobile phase is realized via a section between the column inlet section and the outlet section.

### DESCRIPTION OF THE FIGURES

FIG. 1: An isometric view of an exemplary embodiment of the column according to the invention

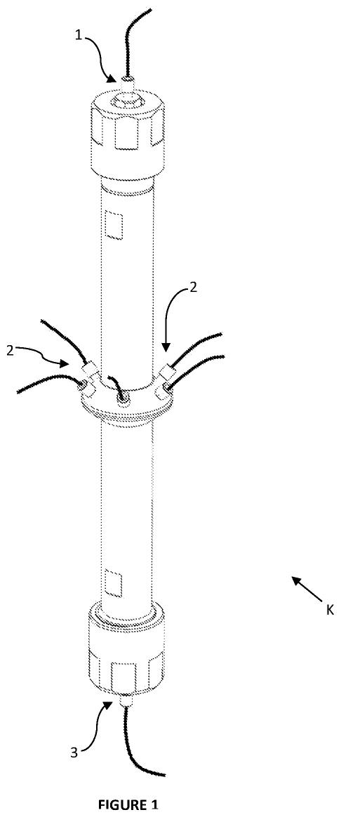

FIG. 2: A sectional view of an exemplary embodiment of the column according to the invention

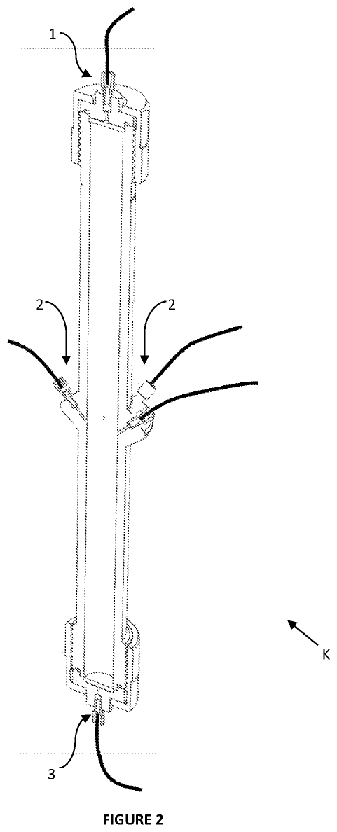

FIG. 3: A front sectional view of an exemplary embodiment of the column according to the invention

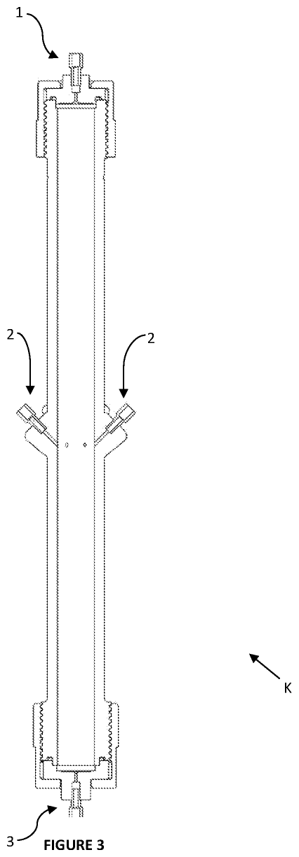

FIG. 4: A view of an exemplary embodiment of the column according to the invention comprising a valve

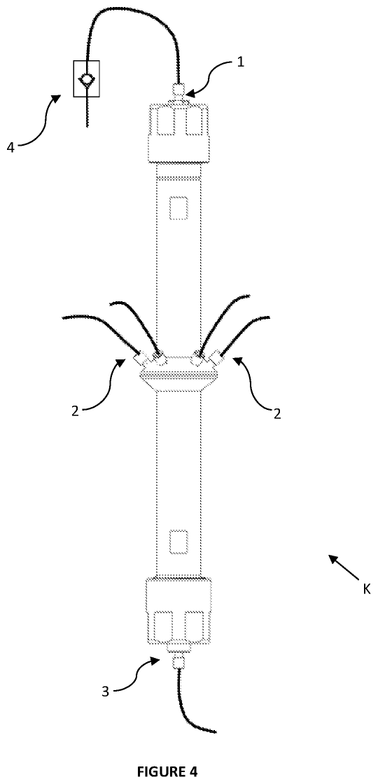

FIG. 5: An isometric view of another exemplary embodiment of the column according to the invention

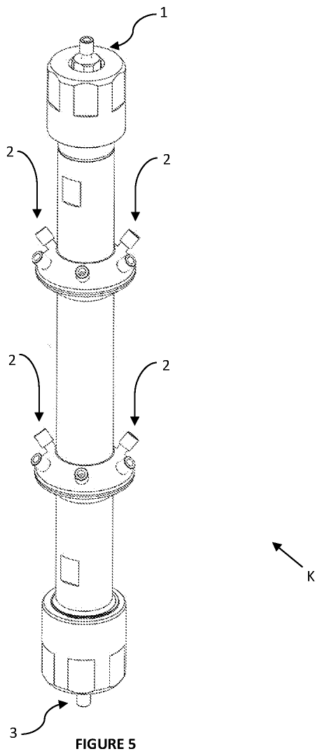

FIG. 6: A view of another exemplary embodiment of the column according to the invention

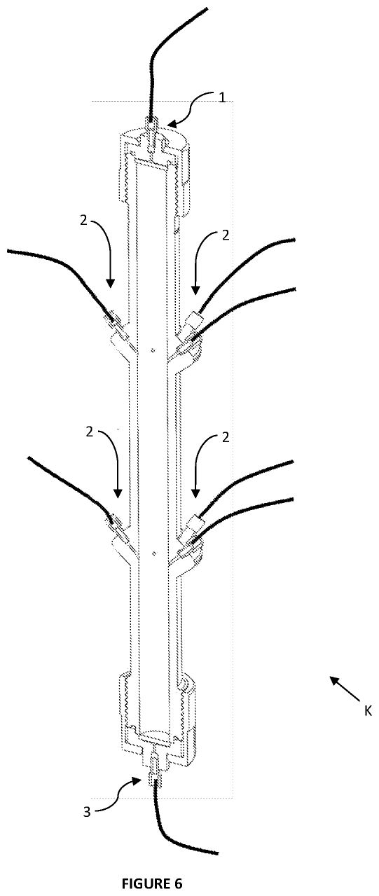

Reference Numerals

| K: | Column |
|---|---|
| 1: | Column inlet |
| 2: | Column assist inlet |
| 3: | Column outlet |
| 4: | Valve |

### DETAILED DESCRIPTION OF THE INVENTION

The invention relates to a separation column (K) used for separating the substances in a mixture. More particularly, the invention relates to a separation column (K) comprising an additional inlet where the input of the mobile phase may be realized via a section between the column inlet (1) and column outlet (3) of said column (K), in addition to the column inlet (1).

Via the extraction chromatography technique, two or more substances with very similar chemical properties may be separated from one another. The substances to be separated are charged in the column (K) along with an acid of certain molarity. Then, the acid with a different molarity is passed through the column (K) to advance the charged substances within the column (K). The substances to be subjected to separation move at a certain velocity downward from the top along the upright column (K). The substances to be subjected to separation and the acid are charged at a certain pressure in the system and the movement required for separation takes place under the influence of said pressure.

In addition to the column inlet (1) where the mobile phase, more specifically the substance to be separated and/or the acid, is charged in the column (K), the column (K) according to the invention has at least one column assist inlet (2), which is located between the column inlet (1) and the column outlet (3) and which serves to feed additional mobile phase, preferably acid. The acid charge to the system is realized via said column assist inlet (2), and thus, the pressure inside the column (K) is enabled to be distributed more homogeneously. More particularly, in addition to the column inlet (1), the acid in a pressurized state is charged via the column assist inlet (2) also, and thus, the drop in the pressure that occurs from the column inlet (1) towards the column outlet (3) is prevented.

A preferred embodiment of the invention comprises more than one column assist inlet (2) at a location between the column inlet (1) and the column outlet (3).

In a preferred embodiment of the invention, at least one plug is located at the column inlet (1) end and/or column outlet (3) end of the body of the column (K). Said plugs are secured via at least one cap so that they can resist the pressure inside the body of the column (K). Said cap is preferably a threaded cap.

In a preferred embodiment of the invention, the column (K) has a circular cross-section.

In a preferred embodiment of the invention, the pressures of the phases fed via the column inlet (1) and the column assist inlet (2) are equal. In other words, the column assist inlet (2) is a column assist inlet (2) having a structure able to allow the mobile phase to be fed at a pressure equal to the pressure of the phase fed via the column inlet (1). In a preferred embodiment of the invention, the mobile phase is fed via the column inlet (1) and the column assist inlet (2) at a pressure in the range of 15-25 bar depending on the size of the column (K).

A preferred embodiment of the invention comprises at least one valve (4) permitting unidirectional liquid movement. While said valve (4) permits the entry of liquid into the column (K), it prevents the exit of liquid from within the column (K). In a preferred embodiment of the invention, said valve (4) is positioned at the column inlet (1) and/or the column assist inlet (2).

The separation with the column (K) according to the invention is performed via the following process steps:
Charging the radioactive substance in the column (K) via the column inlet (1) and/or the column assist inlet (2) with an acid of certain molarity,
the radioactive substance accumulating in the top portion of the body of the column (K), more specifically at the column inlet (1) end,
directing the acid used for charging to the drain via the column outlet (3),
changing the molarity of the acid introduced to the column inlet (1) and/or the column assist inlet (2), and thus, enabling the charged radioactive materials desired to be subjected to separation to move inside the column (K),
after the start of said movement, the radioactivity detector detecting the activity of the mixture within the column (K), and
moving on to the next process step according to the activity detected.

The movement mentioned in the step of changing the molarity of the acid introduced to the column inlet (1) and/or the column assist inlet (2), and thus, enabling the charged radioactive materials desired to be subjected to separation to move inside the column (K) is from the column inlet (1) end towards the column outlet (3) end.

In a preferred embodiment of the invention, said column (K) is a column (K) used for the separation of the rare earth elements. In another preferred embodiment of the invention, said column (K) is a column (K) used for the separation of the radioactive substances. In another preferred embodiment of the invention, said column (K) is a column (K) used for the separation of ytterbium and lutetium. More particularly, it is a column (K) used for the separation of ytterbium 176 (Yb-176) isotope and lutetium 177 (Lu-177) isotope.

The pressure-assisted separation column (K) according to the invention is used in the chromatography devices enabling the separation of more than one radioactive substance. Said chromatography device, which is used for the separation of radioactive substances and which comprises said pressure-assisted separation column (K), is also within the scope of the invention.

In a preferred embodiment of the invention, at least one detector is used for detecting the activity inside the column (K) wherein said detector is a detector capable of moving along the column (K). In this way, the position and/or distribution and/or movement speed may be detected along the column (K) for the substances moving through said column (K) and/or the time of exit of said substances from said column (K) may be detected.

1. A separation column used for separating substances in a mixture wherein a column, in addition to a column inlet where a mobile phase is charged in said column, has at least one column assist inlet, via which additional mobile phase may be charged in said column.

2. A separation column according to claim 1, wherein the column, in addition to the column inlet where the mobile phase, i.e. the substance to be separated and/or the acid, is charged in said column, has at least one column assist inlet, which allows additional acid to be charged in said column.

3. A separation column according to claim 1, wherein the column assist inlet is an inlet located between the column inlet and a column outlet.

4. A separation column according to claim 1, wherein the column comprises more than one column assist inlet between the column inlet and a column outlet.

5. A separation column according to claim 1, wherein the column is a column having a circular cross-section.

6. A separation column according to claim 1, wherein the column assist inlet is a column assist inlet having a structure that will enable a phase at a pressure equal to the pressure of the phase fed via the column inlet to be fed into the column.

7. A separation column according to claim 6, wherein the column assist inlet is a column assist inlet having a structure that will allow the phase to be fed into the column at a pressure of 15-25 bar depending on the size of said column.

8. A separation column according to claim 1, wherein the column is a column used for the separation of rare earth elements.

9. A separation column according to claim 1, wherein the column is a column used for the separation of radioactive substances.

10. A separation column according to claim 1, wherein the column is a column used for the separation of ytterbium and lutetium.

11. A separation column according to claim 10, wherein the column is a column used for the separation of ytterbium 176 isotope and lutetium 177 isotope.

12. A separation column according to claim 1, wherein the column comprises at least one plug at the column inlet end and/or column outlet end of the body of the column.

13. A separation column according to claim 12, wherein said plugs are secured via at least one cap so that they can resist the pressure inside the body of the column.

14. A separation column according to claim 13, wherein said cap is a threaded cap.

15. A separation column according to claim 1, wherein the column comprises at least one valve permitting unidirectional liquid movement.

16. A separation column according to claim 15, wherein the valve is a valve which permits the entry of liquid into the column while preventing the exit of liquid from within the column.

17. A separation column according to claim 15, wherein the valve is positioned at the column inlet and/or the column assist inlet.

18. A chromatography device used for the separation of more than one radioactive substance wherein the chromatography device comprises the column according to claim 1, having, in addition to the column inlet where the mobile phase is charged in said column, at least one column assist inlet, via which additional mobile phase may be charged in said column.

19. Separation method used for separating the substances in a mixture via a separation column wherein the separation method comprises the steps of:
charging radioactive substance in the column via a column inlet and/or a column assist inlet with an acid of certain molarity,
the radioactive substance accumulating in a top portion of the body of the column, more specifically at the column inlet end,
directing acid used for charging to a drain via a column outlet,
changing the molarity of acid introduced to the column inlet and/or the column assist inlet, and thus, enabling the charged radioactive materials desired to be subjected to separation to move inside the column, and
after the start of said movement, a radioactivity detector detecting the activity of the mixture within the column.

20. A separation method according to claim 19, wherein the movement in the step of changing the molarity of acid introduced to the column inlet and/or the column assist inlet, and thus, enabling the charged radioactive materials desired to be subjected to separation to move inside the column is from the column inlet end towards the column outlet end.
